(19) United States
(12) Patent Application Publication
(10) Pub. No.: US 2006/0092448 A1
(43) Pub. Date: May 4, 2006

(54) Apparatus for forming image expected by user, system, method and program

(76) Inventor: Masahiro Machida, Ebina-shi (JP)

Correspondence Address: GAUTHIER & CONNORS, LLP, 225 FRANKLIN STREET, BOSTON, MA, 02110, US

(21) Appl. No.: 11/076,679

(22) Filed: Mar. 10, 2005

(30) Foreign Application Priority Data
Nov. 4, 2004 (JP) 2004-320062

(51) Int. Cl. G06F 15/00

(52) U.S. Cl. 358/1.13; 358/1.15

(57) ABSTRACT

When a request for a start instruction is input from an operation panel of an image forming apparatus, an image forming processing section creates usage environment information including content of settings for the image forming apparatus; information identifying the image forming apparatus, such as an IP address; and information on the capabilities of connected equipment, such as a finisher, and the image forming apparatus, and then sends the information to a server specified by a user together with the request for an instruction to start a processing. The server creates an HTML file in which a processing to be performed is described with reference to the received usage environment information and sends it to the image forming apparatus. The image forming apparatus processes and executes the received HTML file to display a setting screen on the operation panel, and then performs the processing in accordance with conditions inputted from the setting screen.

### BACKGROUND OF THE INVENTION

1. Field of the Invention

The present invention relates to the provision of a system including an image forming apparatus or an external apparatus using an image forming apparatus, and more particularly to an apparatus for affording convenience to a user of an image forming apparatus.

2. Description of the Related Art

Many complex image forming apparatuses are provided with an operation panel as a user interface, through which a user can input and set conditions and the like to thereby operate the image forming apparatus. For example, for a copy function, the number of copies or sets of copies, whether or not sorting is to be performed, and the like are input and set. If a finisher is mounted, a binding position can also be set using the operation panel.

Recently, in response to marketplace wishes and usage specific to users, image forming apparatuses have been provided with greater numbers of functions. For example, some image forming apparatuses are configured to be equipped with a browser so that HTML files and the like sent from a server via a network can be processed and executed in the image forming apparatuses.

A specific use procedure will be described using an example. When a user performs a predetermined operation using the operation panel of an image forming apparatus, the image forming apparatus sends a request to acquire an HTML file to a server in response to the operation. The image forming apparatus processes and executes an HTML file sent from the server to create a setting screen and displaying this screen on the operation panel. By inputting desired setting conditions from the displayed setting screen, the user instructs the image forming apparatus to perform a desired processing, for example, a procedure from reading to bookbinding of a document. The image forming apparatus creates an output requested by the user in accordance with the input setting conditions.

Thus, it is known to provide an image forming apparatus that can provide a service customized for a user, such as creation of a setting screen and a procedure.

Such an image forming apparatus, however, cannot in all instances create the output desired by the user, even if it is able to receive an HTML file and perform processing. For example, the functions of a browser provided in an image forming apparatus are often restricted, and do not offer all the functions of a browser used on a personal computer. Therefore, if an instruction requiring a restricted function is included, the image forming apparatus cannot operate as instructed. As another example, if a finisher is not connected to the image forming apparatus, the image forming apparatus cannot perform the processing of binding printed sheets even when binding processing is instructed.

These problems occur because an image forming apparatus is not provided with means for notifying a user (in the above example, a server) of the usage environment of the image forming apparatus, such as content of settings for the image forming apparatus and connected hardware and the like, and a user must therefore create and send to the image forming apparatus an HTML file for performing a desired processing without consideration of the usage environment of the image forming apparatus.

When it is undesirable to notify all the users of the usage environment of an image forming apparatus, a method for performing limited or restricted notification would be useful.

### SUMMARY OF THE INVENTION

The present invention has been made in view of the above circumstances and provides an image forming apparatus capable of enhancing user convenience.

According to one aspect of the present invention, an image forming apparatus for performing a processing in accordance with start instruction information sent from an external apparatus via a network in response to an instruction input by a user through an operation panel, the image forming apparatus includes creation unit that creates usage environment information related to the image forming apparatus including at least one of content of settings for the image forming apparatus, information identifying the image forming apparatus, and information on the capabilities of the image forming apparatus; notification unit that sends the usage environment information to the external apparatus; receiver that receives start instruction information created with reference to the usage environment information sent by the notification unit; and an execution unit that performs a processing in accordance with the start instruction information received by the receiver.

An image forming system according to another aspect of the present invention is an image forming system includes an image forming apparatus according to any of the inventions described above and the external apparatus, the external apparatus comprising receiver that receives the usage environment information sent by the image forming apparatus; a creation unit that creates start instruction information for instructing start of a processing in the image forming apparatus, with reference to the received usage environment information; and a sending unit that sends the created start instruction information to the image forming apparatus.

An image forming method according to the present invention is performed by a computer mounted on an image forming apparatus for performing a processing in accordance with start instruction information sent from an external apparatus in response to an instruction input by user through an operation panel and by the external apparatus. Such a method may comprise the computer sending usage environment information about the image forming apparatus including content of settings for the image forming apparatus and ability information about the image forming apparatus to the external apparatus when a request for a start instruction to the external apparatus is input through from the operation panel; the external apparatus receiving the usage environment information sent by the computer, creating start instruction information for instructing start of a processing in the image forming apparatus, with reference to the received usage environment information, and sending the start instruction information to the computer; and the computer receiving the start instruction information sent by the external apparatus and performing the processing in accordance with the received start instruction information.

An image forming program according to another aspect of the present invention causes a computer mounted on an image forming apparatus for performing a processing in accordance with start instruction information sent from an external apparatus in response to an instruction input through from an operation panel, to function as notification means for sending usage environment information of the image forming apparatus including at least one of content of settings for the image forming apparatus, information identifying the image forming apparatus, and information on the capabilities of the image forming apparatus to the external apparatus when a request for a start instruction to the external apparatus is input through the operation panel; receiving means for receiving start instruction information created with reference to the usage environment information sent by the notification means; and execution means for performing a processing in accordance with the start instruction information received by the receiving means.

### BRIEF DESCRIPTION OF THE DRAWINGS

Embodiments of the present invention will be described in detail based on the following figures, wherein:

FIG. 1 is a block diagram of an image forming system including an embodiment of an image forming apparatus according to the present invention;

FIG. 2 is a flowchart showing the operation of an image forming apparatus in an Embodiment 1 of the present invention;

FIG. 3 shows an example of data configuration of an information management table in an Embodiment 2 of the present invention; and

FIG. 4 is a flowchart showing the operation of an image forming apparatus in an embodiment 2.

### DESCRIPTION OF THE PREFERRED EMBODIMENTS

Embodiments of the present invention will be now described below based on the drawings.

### Embodiment 1

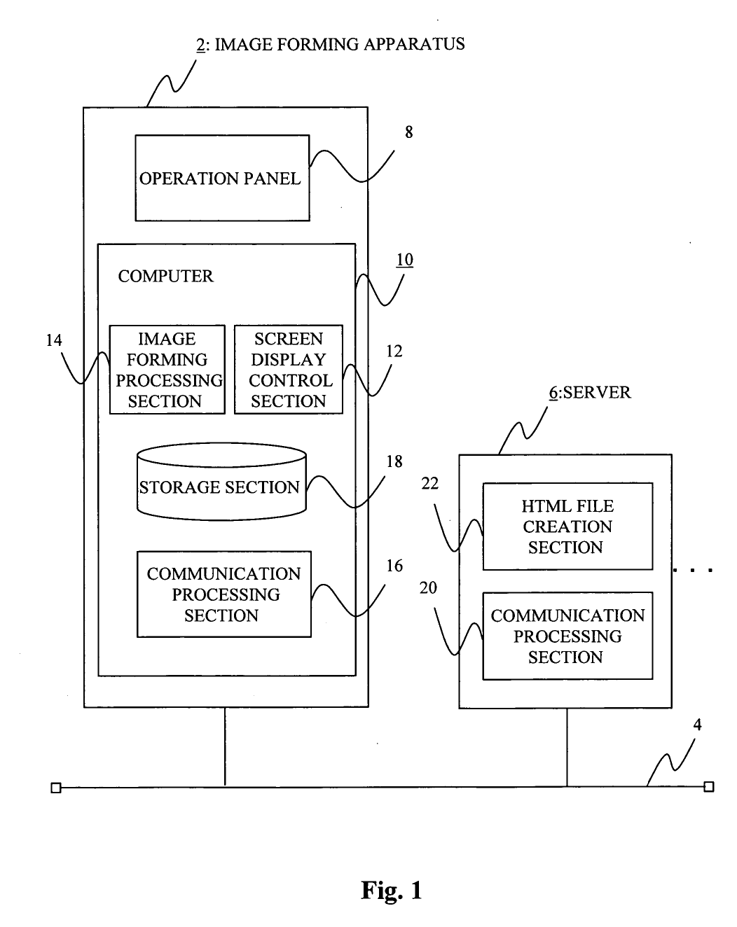

FIG. 1 is a block diagram of an image forming system including an embodiment of an image forming apparatus according to the present invention. In FIG. 1, there are shown an image forming apparatus 2 and a server 6 which performs data communication with the image forming apparatus 2 via a network 4. Although multiple servers 6 can be connected to the network 4, as the same configuration can be applied to multiple servers, for ease of understanding only one server 6 is shown in FIG. 1. The network 4 may be an intranet or a wide area network such as the Internet.

The image forming apparatus 2 in this embodiment is assumed to be a complex machine in which additional devices such as a finisher and a document feeder are connectably included and which is provided with a copy function, a fax function, a scanner function, and the like as basic functions.

A computer 10 has a screen display control section 12, an image forming processing section 14, a communication processing section 16, and a storage section 18. The screen display control section 12 controls display of various setting screens on an operation panel 8 of the image forming apparatus 2. For example, for a copy function, display of any setting screen or the like is performed by performing a processing in accordance with content described in a file for image forming, such as an HTML file, in addition to existing functions such as displaying a setting screen for setting the size of paper, the number of copies, and the like. The image forming processing section 14 is means for performing the entire image forming processing in the image forming apparatus 2, and the image forming processing section 14 in this embodiment has a function of collecting usage environment information about the image forming apparatus, including at least one of content of settings for the image forming apparatus, information identifying the image forming apparatus, and information on the capabilities of the image forming apparatus. The content of settings for the image forming apparatus includes the names of installed software, such as a controller and a browser, and the version information about the software. The information identifying the image forming apparatus includes information such as a product model number (a product code) and a network address (an IP address). The information on the capabilities of the image forming apparatus includes mounted functions, performance, and the like, although this information may also be determined from the product code. Furthermore, in addition to information related to the image forming apparatus, configuration information concerning additional equipment connected to the image forming apparatus, such as a finisher, is also included. The image forming processing section 14 stores an HTML file received from the server 6 and collected usage environment information in the storage section 18. The communication processing section 16 performs data communication with the server 6 via the network 4. The processing functions of the screen display control section 12, the image forming processing section 14 and the communication processing section 16 are realized by an operation performed by the computer 10 and software for realizing the processing functions in cooperation with each other.

The server 6 has a communication processing section 20 and an HTML file creation section 22. The communication processing section 20 performs data communication processing with the image forming apparatus 2 via the network 4. When receiving the usage environment information sent from the image forming apparatus 2 via the communication processing section 20, the HTML file creation section 22 creates an HTML file with reference to the usage environment information. The HTML file creation section 22 then sends the created HTML file to the image forming apparatus 2 via the communication processing section 20. The server 6 is realized by a general-purpose computer, and the processing functions of the communication processing section 20 and the HTML file creation section 22 are realized by an operation performed by hardware provided for the server 6 and software for realizing the processing functions in cooperation with each other.

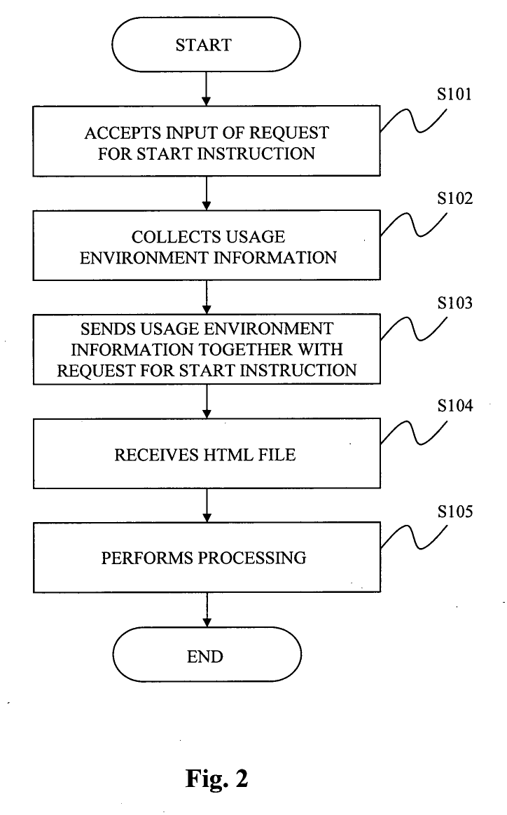

The operation in this embodiment will be now described using the flowchart shown in FIG. 2. Here, a specific example of use of the image forming apparatus 2 by a user of the server 6 will be described to illustrate the embodiment.

In order to cause the image forming apparatus 2 to perform a desired processing, a user performs a predetermined operation for requesting an instruction to start the processing, using the operation panel 8 of the image forming apparatus 2. When a desired processing is performed by processing and executing an HTML file, a request for an instruction to start the processing and a request for acquisition of an HTML file have the same meaning in this embodiment. When accepting a request for a start instruction input from the operation panel 8 (step 101), the image forming processing section 14 collects the usage environment information as described above (step 102). The image forming processing section 14 then sends the usage environment information together with the request for a start instruction, to the server 6 specified by the user from the operation panel 8, via the communication processing section 16 (step 103).

When the communication processing section 20 in the server 6 receives the request for a start instruction which has been sent from the image forming apparatus 2, the HTML file creation section 22 creates an HTML file with reference to the usage environment information about the image forming apparatus 2 sent together with the received request for a start instruction. When executed, the created HTML realizes the processing desired by the user as described above. The HTML file creation section 22 can recognize software installed in the image forming apparatus 2 and the versions thereof, connected equipment, and the like by referencing the usage environment information, and can therefore create an HTML file taking into account the capabilities, settings, and the like of the image forming apparatus 2. For example, when it is recognized that a finisher is not connected, sheet binding is prevented from being included in the desired processing. If the image forming apparatus is not provided with a double-sided copy function or a color mode function, the setting screen generated for display on the operation panel 8 is created without selection buttons for setting double-sided copy or color mode. The HTML file creation section 22 then sends the created HTML file to the image forming apparatus 2 via the communication processing section 16 to issue an instruction to start the processing.

When the communication processing section 16 in the image forming apparatus 2 receives the HTML file sent from the server 6 as an instruction to start the processing (step 104), the image forming processing section 14 processes and executes the received HTML file (step 105). For example, the image forming processing section 14 creates a setting screen and causes the screen display control section 12 to display the generated setting screen on the operation panel. When the user inputs desired setting conditions from the displayed setting screen, the image forming processing section 14 processes and executes the HTML file in accordance with the input setting conditions.

The server 6 receives the setting conditions input to the image forming processing section 14, generates a print job for a document stored in the server 6, for example, based on the setting conditions, and sends the generated print job to the image forming apparatus 2. Thereby, the user can cause the image forming apparatus 2 to perform the desired processing.

According to this embodiment, by sending usage environment information about the image forming apparatus 2 to the server 6, the server 6 can create an HTML file in consideration of the settings, capabilities, and the like of the image forming apparatus 2. Thereby, it is ensured that the image forming apparatus 2 can process and execute the HTML file to which the content of the usage environment information is reflected and provide to a user an output desired by the user.

### Embodiment 2

In the Embodiment 1 described above, in response to an input by a user, usage environment information about the image forming apparatus 2 is sent to the server 6 to cause the server 6 to create an HTML file. This usage environment information is information indicating the settings and capabilities of the image forming apparatus 2. As such, the content of the usage environment information should naturally be identical regardless as to which server 6 the usage environment information is sent to and regardless as to which user wishes to use the image forming apparatus 2. However, there may be a case that a user wants to prevent use of a finisher. Accordingly, this embodiment is characterized in that the content of the usage environment information to be sent to the server 6 can be changed by the user.

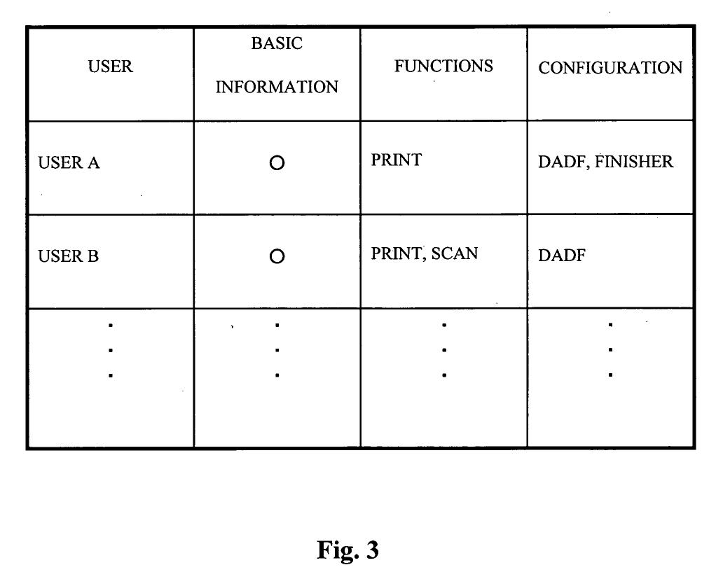

FIG. 3 shows an example of data configuration of an information management table used in this embodiment. In the information management table, the type of information to be included in the usage environment information to be sent to the server 6 can be defined for each user and updated by an administrator or the like. In this embodiment, as an example of data setting, data is set and registered for each of basic information, functions and configuration. The “basic information” is information about the basic settings and capabilities of the image forming apparatus 2 and includes, for example, an IP address, a product name, and a product code. For the “functions”, the functions that the image forming apparatus 2 has are set, such as a copy function, a print function, and a scan function. For the “configuration”, configuration information about equipment connected to the image forming apparatus 2, such as a DADF (a double auto document feeder) and a finisher, is set. In this embodiment, the information management table is retained by the storage section 18. Data may be classified in a different classification manner in the information management table.

The image forming apparatus 2 in this embodiment is mounted with a user authentication function for permitting a user to log in and begin use. However, as this function is well known, it is not described here in detail.

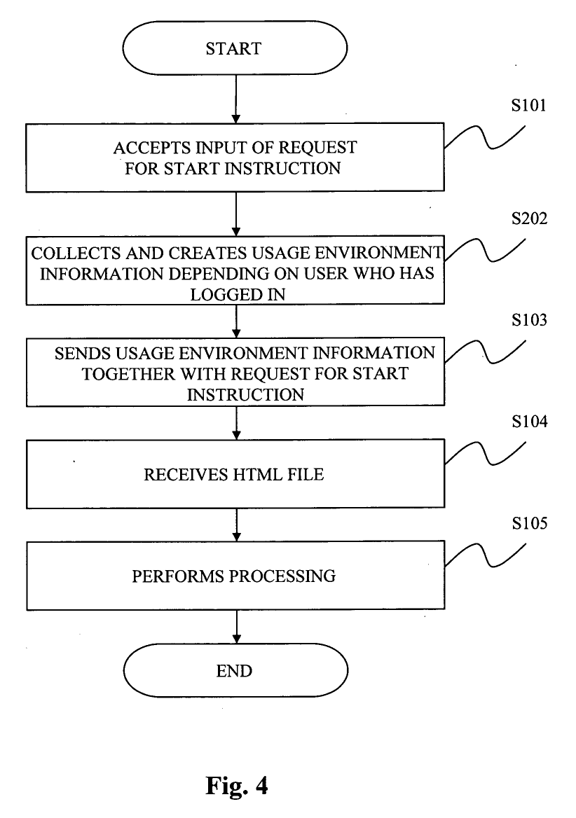

The operation in this embodiment will be now described with the use of a flowchart shown in FIG. 4. Processing steps corresponding to those in Embodiment 1 are denoted by the same step numbers.

After logging onto the image forming apparatus 2 to cause the image forming apparatus 2 to perform a desired processing, the user performs a predetermined operation for requesting an instruction to start the processing, using the operation panel 8. When receiving the request for a start instruction input through the operation panel 8 (step 101), the image forming processing section 14 collects and creates usage environment information similar as in Embodiment 1 (step 202). In Embodiment 2, however, the creation is performed as described below.

That is, the image forming processing section 14 identifies the user who has logged in and selects the type of information to be collected for the user who has logged in, with reference to an information management table. In the case of a user A, for example, the usage environment information is created with basic information, information indicating that a mounted function is a print function and information indicating that connected pieces of equipment are a DADF and a finisher included therein. In the case of a user B, the usage environment information is created with basic information, information indicating that mounted functions are a print function and a scan function, and information indicating that connected equipment is a DADF included therein. Thus, in this embodiment, information about a function or configuration implemented for the image forming apparatus 2 is not notified if it is not specified in the information management table associated with the user then logged in.

After selecting the type of information to be included in the usage environment information according to the user who has logged in with reference to an information management table, as described above, the image forming processing section 14 sends the usage environment information together with the request for a start instruction to a server 6 specified by the user from the operation panel 8, via the communication processing section 16 (step 103).

When the communication processing section 20 in the server 6 receives the request for a start instruction sent from the image forming apparatus 2, the HTML file creation section 22 creates an HTML file with reference to the usage environment information about the image forming apparatus 2 sent together with the received request for a start instruction. This HTML-file creation processing is similar to that in the Embodiment 1. In this embodiment, however, the HTML file is created with reference to the usage environment information consisting of information selected for the presently logged-in user of the apparatus. The HTML file creation section 22 issues an instruction to start a processing by sending the HTML file created as described above to the image forming apparatus 2 via the communication processing section 16.

The subsequent processings performed in the image forming apparatus 2 are similar to those in the Embodiment 1. When receiving the HTML file sent from the server 6 (step 104), the image forming processing section 14 processes and executes the received HTML file (step 105). Thereby, the desired processing is performed by means of the functions and the capabilities of the image forming apparatus 2 as limited to or by the logged in user.

According to this embodiment, the same effect as the Embodiment 1 can be provided, while the functions, capabilities, and the like of the image forming apparatus 2 used for performing a desired processing can additionally be limited for each user. Although limitation of functions and the like is performed for each user in the example used to illustrate this embodiment, it is also possible to maintain and manage information about a group to which each user belongs and select functions, capabilities, and the like according to the group to which a particular user is assigned.

In both of the above embodiments, usage environment information regarding functions, capabilities, and the like of the image forming apparatus 2 is collected and created when a request for a start instruction is input, and then sent to the server 6, which is an external apparatus, together with the request for an instruction to start a processing. According to the above processing, information corresponding to the current situation can be provided to the server 6 by collecting and creating the usage environment information when a request for a start instruction is input. However, it is not necessarily required that collection, creation, and sending of the usage environment information be performed simultaneous with a request for a start instruction. For example, it is also possible to create and to send the usage environment information to an external apparatus pre-registered with the storage section 18 when the image forming apparatus 2 is powered on. Alternatively, this may be performed when connection to the network 4 is confirmed. In the case of Embodiment 2, it is also possible that this is performed when a user logs in. Furthermore, it is also possible to create usage environment information in advance, store it in the storage section 18, and then, when a request for a start instruction is input from the operation panel 8, read the usage environment information from the storage section 18 and send it to the server 6.

The entire disclosure of Japanese Patent Application No. 2004-320062 including specification, claims, drawings and abstract is incorporated herein by reference in its entirety.

What is claimed is:

1. An image forming apparatus for performing a processing in accordance with start instruction information sent from an external apparatus via a network in response to an instruction input by a user through an operation panel, the image forming apparatus comprising:
a creation unit that creates usage environment information related to the image forming apparatus including at least one of content of settings for the image forming apparatus, information identifying the image forming apparatus, and information on the capabilities of the image forming apparatus;
a notification unit that sends the usage environment information to the external apparatus;
a receiver that receives start instruction information created with reference to the usage environment information sent by the notification unit; and
an execution unit that performs a processing in accordance with the start instruction information received by the receiver.

2. The image forming apparatus according to claim 1, wherein
the information identifying the image forming apparatus is a product code.

3. The image forming apparatus according to claim 1, wherein
the information identifying the image forming apparatus is an address used for network communication.

4. The image forming apparatus according to claim 1, wherein
the content of settings for the image forming apparatus is version information of installed software.

5. The image forming apparatus according to claim 1, wherein
the information on the capabilities of the image forming apparatus is configuration information related to equipment connected to the image forming apparatus.

6. The image forming apparatus according to claim 1, further comprising:
an identifying unit that identifies a user logged onto the image forming apparatus;
an information management table in which available information for each user is defined; and
a selecting unit that selects the type of information to be included in the usage environment information to be sent to the external apparatus by the notification unit, for the user who has logged in, with reference to the information management table.

7. The image forming apparatus according to claim 6, wherein
the notification unit sends the usage environment information when the image forming apparatus is powered on, when provision of a service is started via the network, when a user logs in, or when a request for a start instruction to the external apparatus is input through the operation panel.

8. The image forming apparatus according to claim 1, wherein
the notification unit sends the usage environment information when the image forming apparatus is powered on, when provision of a service is started via the network, when a user logs in, or when a request for a start instruction to the external apparatus is input through the operation panel.

9. An image forming system comprising an external apparatus and an image forming apparatus for performing a processing in accordance with start instruction information sent from the external apparatus via a network in response to an instruction input by a user through an operation panel, the image forming system comprising:
a creation unit that creates usage environment information related to the image forming apparatus, including at least one of content of settings for the image forming apparatus, information identifying the image forming apparatus, and information on the capabilities of the image forming apparatus;
a notification unit that sends the usage environment information to the external apparatus;
a receiver that receives start instruction information created with reference to the usage environment information sent by the notification unit; and
a execution unit that performs a processing in accordance with the start instruction information received by the receiver,
the external apparatus comprising:
a receiver that receives the usage environment information sent by the image forming apparatus;
a creation unit that creates start instruction information for instructing start of a processing in the image forming apparatus, with reference to the received usage environment information; and
a sending unit that sends the created start instruction information to the image forming apparatus.

10. The image forming system according to claim 9, wherein
the information identifying the image forming apparatus is a product code.

11. The image forming system according to claim 9, wherein
the information identifying the image forming apparatus is an address used for network communication.

12. The image forming system according to claim 9, wherein
the content of settings for the image forming apparatus is version information of installed software.

13. The image forming system according to claim 9, wherein
the information on the capabilities of the image forming apparatus is configuration information related to equipment connected to the image forming apparatus.

14. The image forming system according to claim 9, further comprising:
an identifying unit that identifies a user who has logged onto the image forming apparatus;
an information management table in which available information for each user is defined; and
a selecting unit that selects the information to be included in the usage environment information to be sent to the external apparatus by the notification unit, for the identified user of the image forming apparatus, with reference to the information management table.

15. The image forming system according to claim 14, wherein
the notification unit send the usage environment information when the image forming apparatus is powered on, when provision of a service is started via the network, when a user logs in, or when a request for a start instruction to the external apparatus is input through the operation panel.

16. The image forming system according to claim 9, wherein
the notification unit send the usage environment information when the image forming apparatus is powered on, when provision of a service is started via the network, when a user logs in, or when a request for a start instruction to the external apparatus is input through the operation panel.

17. An image forming method to be performed by a computer mounted on an image forming apparatus for performing a processing in accordance with start instruction information sent from an external apparatus in response to an instruction input by a user through an operation panel, and by the external apparatus, the method comprising:
the computer sending usage environment information concerning the image forming apparatus including content of settings for the image forming apparatus and ability information about the image forming apparatus to the external apparatus when a request for a start instruction to the external apparatus is input through the operation panel;
the external apparatus receiving the usage environment information sent by the computer, creating start instruction information for instructing start of a processing in the image forming apparatus, with reference to the received usage environment information, and sending the start instruction information to the computer; and
the computer receiving the start instruction information sent by the external apparatus and performing the processing in accordance with the received start instruction information.

18. An image forming program for causing a computer mounted on an image forming apparatus for performing a processing in accordance with start instruction information sent from an external apparatus in response to an instruction input by a user through an operation panel, to function as:
notification means for sending usage environment information of the image forming apparatus including at least one of content of settings for the image forming apparatus, information identifying the image forming apparatus, and information on the capabilities of the image forming apparatus, when a request for a start instruction to the external apparatus is input through the operation panel;
receiving means for receiving start instruction information created with reference to the usage environment information sent by the notification means; and
execution means for performing a processing in accordance with the start instruction information received by the receiving means.
